(19) United States
(12) Patent Application Publication
(10) Pub. No.: US 2003/0056214 A1
(43) Pub. Date: Mar. 20, 2003

(54) Apparatus for and method of distributing a moving picture with a commercial, a recording medium and a distribution requesting apparatus

(75) Inventors: Miwako Yuasa, Tokyo (JP); Kazuhiro Kita, Tokyo (JP); Tetsuichi Yuasa, Tokyo (JP)

Correspondence Address: John W. Carpenter, Crosby, Heafey, Roach & Mey, Suite 2000, 2 Embarcadero Center, San Francisco, CA, 94111, US

(73) Assignee: Sony Corporation

(21) Appl. No.: 10/151,672

(22) Filed: May 20, 2002

(30) Foreign Application Priority Data
Sep. 20, 2001 PCT/JP01/08181

(51) Int. Cl. H04N 7/025; H04N 7/10; H04N 7/173

(52) U.S. Cl. 725/32; 725/110

(57) ABSTRACT

An apparatus for distributing a moving picture with a commercial includes a setting means (3) for setting category information indicative of respective categories to a plurality of distributed moving image data and a plurality of distributed commercial image data, the setting means (3) for setting distribution source information indicative of respective data distribution sources to the moving image data and the commercial image data, a selecting means (10) for selecting commercial image data to which any of category information and any of distribution source information are set based upon category information and distribution source information set to the moving image data each time a distribution request of any of moving image data is received through a communication network (15) which is capable of executing a two-way communication and a coupling means (11) for coupling the commercial image data selected by the selecting means (10) to the moving image data whose distribution was requested, wherein the moving image data with the commercial image data coupled thereto by the coupling means (11) is distributed to a transmission source of a distribution request via the communication network (15). Thus, when a moving picture with a commercial is distributed through the Internet, it is possible to increase a rate at which a commercial can attract a viewer's attention.

### TECHNICAL FIELD

The present invention relates to a moving picture distribution service capable of distributing a moving picture via a communication network such as the Internet which is able to execute a two-way communication, and particularly to a moving picture distribution service capable of distributing a moving picture together with a commercial.

### BACKGROUND ART

Music distribution services for distributing a piece of music through the Internet and distribution services for distributing a variety of information via the Internet have been spread so far. In accordance with an increase of a data transfer rate and a progress of image compression technologies environments under which a moving picture distribution service for distributing a moving picture via the Internet is made possible are being prepared progressively.

As a form of a business for managing a moving picture distribution service for distributing a moving picture through the Internet, there may be considered a form of a business for earning a distribution charge as an income by distributing a pay moving picture and another form of a business for collecting advertising rates from a sponsor and for earning the advertising rates as an income by distributing a commercial while distributing a free moving picture.

In order to distribute a moving picture with a commercial, one of methods is to uniformly distribute the same commercial regardless of the contents of a moving picture. However, from a standpoint of increasing a rate at which a commercial can attract a viewer's attention (from a standpoint of increasing advertisement effects for sponsors), it is to be appreciated that this method is not so effective in increasing a rate at which a commercial can attract a viewer's attention.

A problem to be solved by the present invention is to increase a rate at which a commercial can attract a viewer's attention when a moving picture with a commercial is distributed via a communication network such as the Internet which is capable of executing a two-way communication.

### DISCLOSURE OF INVENTION

To solve this problem, the applicant of the present application has proposed an apparatus for distributing a moving picture with a commercial and a distribution requesting apparatus which are comprised of a setting means for setting category information indicating categories to a plurality of moving image data and a plurality of commercial image data which are to be distributed, a selecting means for selecting the commercial image data in which any of the category information is set based upon the category information set to the distribution-requested moving image data each time a distribution request of any of the moving image data is received via a communication network capable of executing a two-way communication and a coupling means for coupling commercial image data selected by the selecting means to the distribution-requested moving image data, wherein moving image data to which commercial image data is coupled by the coupling means is distributed to the transmission source of the distribution request via the communication network.

In the apparatus for distributing a moving picture with a commercial and the distribution requesting apparatus, a plurality of moving image data which are to be distributed and a plurality of commercial image data which are to be distributed are classified into respective categories by setting respective category information. Then, when a distribution request of moving image data is received, commercial image data of any of categories is selected based upon the category of that moving image data, and the above commercial image data is coupled to the moving image data and thereby distributed to a transmission source of a distribution request.

As described above, when a category of a commercial is selected at every category of a distribution-requested moving picture, a commercial of a category which receives an interest of a high degree from a viewer who has sent a distribution request can be distributed. Thus, it is possible to increase a rate at which a commercial can attract a viewer's attention.

In the apparatus for distributing a moving picture with a commercial and the distribution requesting apparatus, by way of example, the selecting means may select commercial image data to which the same category information as the distribution-requested moving image data is set. According to this arrangement, since the commercial of the same category as that of the desired moving picture which the viewer wants to watch is distributed, it is possible to increase a rate at which a commercial can attract a viewer's attention.

When moving image data supplied from other person is distributed, by way of example, the above apparatus may further include a setting means for setting distribution source information indicative of respective data distribution sources to moving image data and commercial image data and the selecting means may select the commercial image data to which any of distribution source information is set based upon the distribution source information set to the moving image data whose distribution was requested.

In this manner, when a commercial is selected at every distribution source of a moving picture whose distribution was requested, it is possible to avoid such a situation in which a commercial from a distribution source (a different company of the same business) which competes with a certain distribution source is distributed together with a moving picture supplied from a certain distribution source.

By way of example, the above apparatus may further include a setting means for setting time zone information indicative of distribution time zones to the commercial image data, and the selecting means may select commercial image data to which time zone information coincident with a time zone which received a distribution request is set. According to this arrangement, since a commercial suitable for the time zone whose distribution was requested is distributed, it is possible to further increase a rate at which a commercial can attract a viewer's attention.

Next, there are proposed a method of distributing a moving picture with a commercial which is comprised of a first step of setting category information indicative of respective categories to a plurality of moving image data which are to be distributed and a plurality of commercial image data which are to be distributed, a second step of selecting commercial image data to which any of category information is set based upon the category information set to the moving image data whose distribution was requested each time a distribution request of any moving image data is received through a communication network which is capable of executing a two-way communication, a third step of coupling the commercial image data selected at the second step to the moving image data whose distribution was requested and a fourth step of distributing the moving image data with the commercial image data coupled thereto at the third step through this communication network to the transmission source of the distribution request and a recording medium on which the above program is recorded.

According to the above method of distributing a moving picture with a commercial and the recording medium on which the above program is recorded, when a category of a commercial is selected at every category of a moving picture whose distribution was requested, the commercial of the category which receives an interest of a high degree from a viewer who has sent a distribution request can be distributed. Thus, it is possible to increase a rate at which a commercial can attract a viewer's attention.

Also in this method of distributing a moving picture with a commercial and the recording medium on which the above program is recorded, by way of example, the second step may select commercial image data to which the same category information as that of the moving image data whose distribution was requested is set. According to this arrangement, since a commercial of the same category as that of a desired moving picture which the viewer wants to watch is distributed, it is possible to increase a rate at which a commercial can attract a viewer's attention.

When moving image data supplied from other person is distributed, by way of example, the above method may further include a step of setting distribution source information indicative of respective data distribution sources to moving image data and commercial image data and the second step may select the commercial image data to which any of distribution source information is set based upon the distribution source information set to the image data whose distribution was requested.

In this manner, when a commercial is selected at every distribution source of a moving picture whose distribution was requested, it is possible to avoid such a situation in which a commercial from a distribution source (a different company of the same business) which competes with a certain distribution source is distributed together with a moving picture supplied go;: from a certain distribution source.

By way of example, the above method may further include a step of setting time zone information indicative of distribution time zones to the commercial image data, and the second step may select commercial image data to which time zone information coincident with a time zone whose distribution was requested is set. According to this arrangement, since a commercial suitable for the time zone whose distribution was requested is distributed, it is possible to further increase a rate at which a commercial can attract a viewer's attention.

### BRIEF DESCRIPTION OF DRAWINGS

FIG. 1 is a block diagram showing an example of an apparatus for distributing a moving picture with a commercial according to the present invention.

FIG. 2 is a diagram showing examples of categories.

FIG. 3 is a diagram showing examples of ranks.

FIG. 4 is a diagram showing examples of results obtained when added information added to moving picture contents and CM materials are set.

FIG. 5 is a diagram showing examples of results obtained when lists are made.

FIG. 6 is a diagram showing main portions of a display image of a Web page.

FIG. 7 is a flowchart to which reference will be made in explaining a processing executed by a WWW server.

FIG. 8 is a flowchart to which reference will be made in explaining a processing executed by a contents editor.

FIG. 9 is a flowchart to which reference will be made in explaining a processing executed by a CM scheduler.

FIG. 10 is a flowchart to which reference will be made in explaining an example of a file coupling processing.

FIG. 11 is a diagram showing an example of the manner in which a CM material file is coupled to a moving picture contents file.

### BEST MODE FOR CARRYING OUT THE INVENTION

An example in which the present invention is applied to a moving picture distribution service for distributing a moving picture via the Internet will be described below.

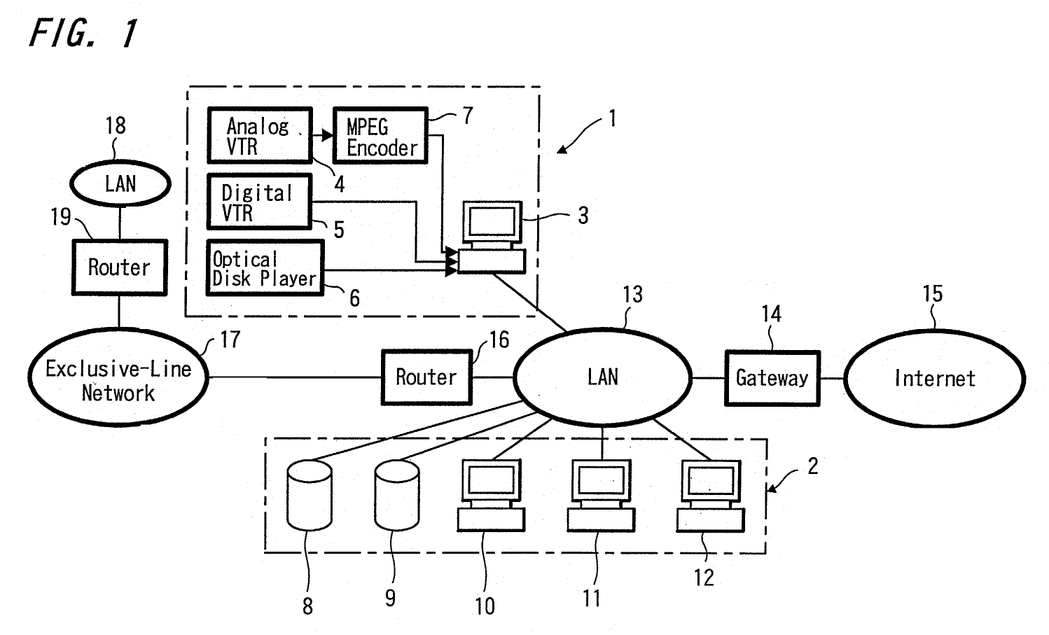

FIG. 1 shows in block form an example of a distribution apparatus for distributing a moving picture with a commercial according to the present invention. This distribution apparatus is roughly classified as an authoring section 1 and a contents transmission section 2.

The authoring section 1 includes an authoring PC (personal computer) 3, an analog VTR 4,a digital VTR 5, an optical disc player (an MO player, a CD player or a DVD player) 6 and an MPEG encoder 7.

The contents transmission section 2 includes a moving picture contents server 8, a CM server 9, a CM scheduler 10, a contents editor 11 and a WWW server 12. The moving picture contents server 8 and the CM server 9 are each comprised of a video server having a plurality of input/output channels. The CM scheduler 10, the contents editor 11 and the WWW server 12 are each comprised of a personal computer (all or any two of the CM scheduler 10, the contents editor 11 and the WWW server 12 may be comprised of a single personal computer).

The authoring PC 3, the moving picture contents server 8, the CM server 9, the CM scheduler 10, the contents editor 11 and the WWW server 12 are connected to each other via a LAN 13.

The LAN 13 is connected through a gateway 14 to the Internet 15. The LAN 13 is connected through a router 16 to an exclusive-line network 17, and a LAN 18 disposed within a distribution source enterprise also is connected through a router 19 to this exclusive-line network 17.

The analog VTR 4, the digital VTR 5 and the optical disk drive 6 are devices for reproducing moving picture data (hereinafter referred to as “moving picture contents”) of distribution targets recorded and distributed in an analog video cassette, a digital video cassette and an optical disk (an MO disk, a write once CD or a write once DVD) from a distribution source enterprise, individuals and an NPO and commercial moving image data (hereinafter referred to as “CM material”) recorded on these mediums and distributed from the distribution source enterprise, respectively.

As examples of distributed moving picture contents, there are enumerated video contents on which a piece of work made by an enterprise in order to advertise its own products is recorded (video contents on which moving pictures exhibiting drive scenes of cars made by a car maker are recorded, etc.), teaching material video contents (video contents on which examples of exercise are recorded, video contents on which lectures are recorded, etc.), video contents on which a concert is recorded, movie video contents for rental use, video contents contributed from individuals or NPO and the like.

Moving picture contents and CM materials reproduced by the analog VTR 4, the digital VTR 5 and the optical disk drive 7 (moving picture contents and CM materials encoded (compressed) by the MPEG encoder 7 after they had been reproduced in the case of the analog VTR 4) are supplied to the authoring PC 3.

The authoring PC 3 is also supplied with moving picture contents and CM materials from the distribution source enterprise via the exclusive-line network 17.

The authoring PC 3 executes an application program which converts the formats of these moving picture contents and CM materials into formats suitable for distribution through the Internet. The moving picture contents thus converted in format are supplied from the authoring PC 3 to the moving picture contents server 8 and recorded as files by the moving picture contents server 8. The CM materials thus converted in format are supplied from the authoring PC 3 to the CM server 9 and recorded as files by the CM server 9.

The authoring PC 3 is used by a user of this moving picture distribution service (hereinafter simply referred to as a “user”) to set predetermined added information added to respective moving picture contents and respective CM materials.

As added information added to moving picture contents, there are enumerated the following ones (a) to (f):

(a): titles of moving picture contents

(b): client names (names of enterprises, individuals and NPO which are moving picture contents distribution sources)

(c): seconds (duration of broadcasting of moving picture contents)

(d): classification of free/pay (classification of free distributed moving picture contents or pay distributed moving picture contents)

(e): categories (fields pertinent to contents of moving picture contents)

(f): enterprise codes (ID codes of fields of enterprises which are moving picture contents distribution sources)

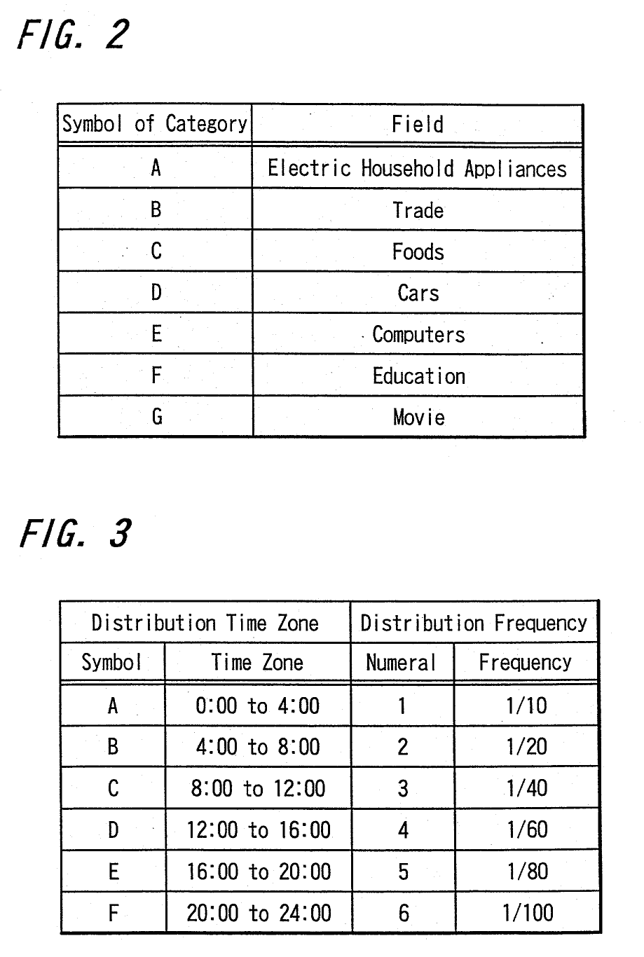

FIG. 2 shows examples of categories. In this example, the category is classified as 7 categories by symbols A to G.

Enterprise codes are unique enterprise numbers following the symbols of the categories of FIG. 2, for example. When the moving picture contents distribution sources are individuals or NPO, these enterprise codes are not set.

The classification of free/pay is determined based on the standard such that free moving picture contents distributed from the distribution source are distributed as free moving picture contents and pay moving picture contents distributed from the distribution source are distributed as pay moving picture contents.

As added information added to CM materials, there are enumerated the following ones (a) to (g):

(a) titles of CM materials

(b): names of sponsors (names of enterprises which are CM material distribution sources)

(c): seconds (duration of broadcasting of CM materials)

(d): ranks (CM material distribution time zone and distribution frequency)

(e): categories (fields pertinent to the contents of CM materials)

(f): enterprise codes (ID codes of fields of sponsors)

(g): distribution periods (contract periods during which CM materials are distributed)

The categories and the enterprise codes are exactly the same as those of the moving picture contents.

FIG. 3 shows the examples of the ranks. In this example, the distribution time zone is classified as six distribution time zones shown by symbols A to F and the distribution frequency is classified as six distribution frequencies by numerals 1 to 6. The distribution time zones of respective CM materials are determined at time zones in which there are many distribution requests from a target sex/age class of the CM material (e.g., CM materials for housewives and children are determined at early time zones till evening and CM materials for elderly men are determined at late time zones after evening). The distribution frequency is a ratio of the number of the distributions of the CM material relative to the number of the distributions of the moving picture contents.

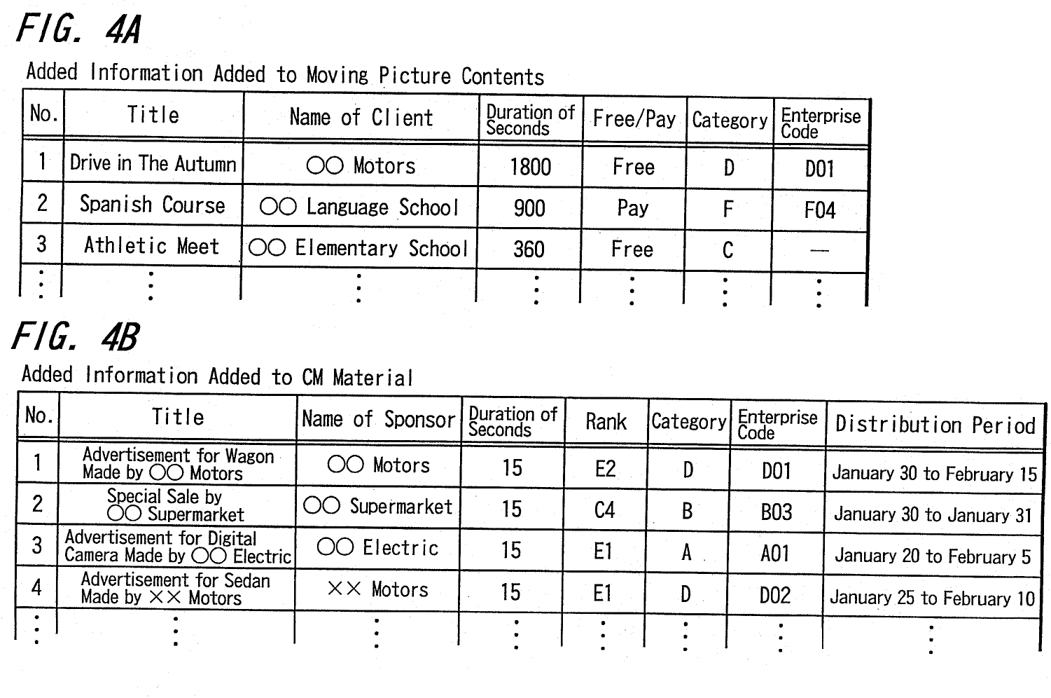

FIGS. 4A and 4B show examples of results obtained when these added information are set to the moving picture contents and the CM materials, respectively.

These added information relative to the moving picture contents and the CM materials are recorded on a hard disk incorporated within the authoring PC 3.

The CM scheduler 10 is used when an operator regularly (e.g., daily) creates a list of CM materials of every categories distributed to each time zone based upon added information recorded on the CM server 9. A frequency at which each CM material is on the list is determined based upon the distribution frequency in the rank (FIG. 3) of the corresponding CM material.

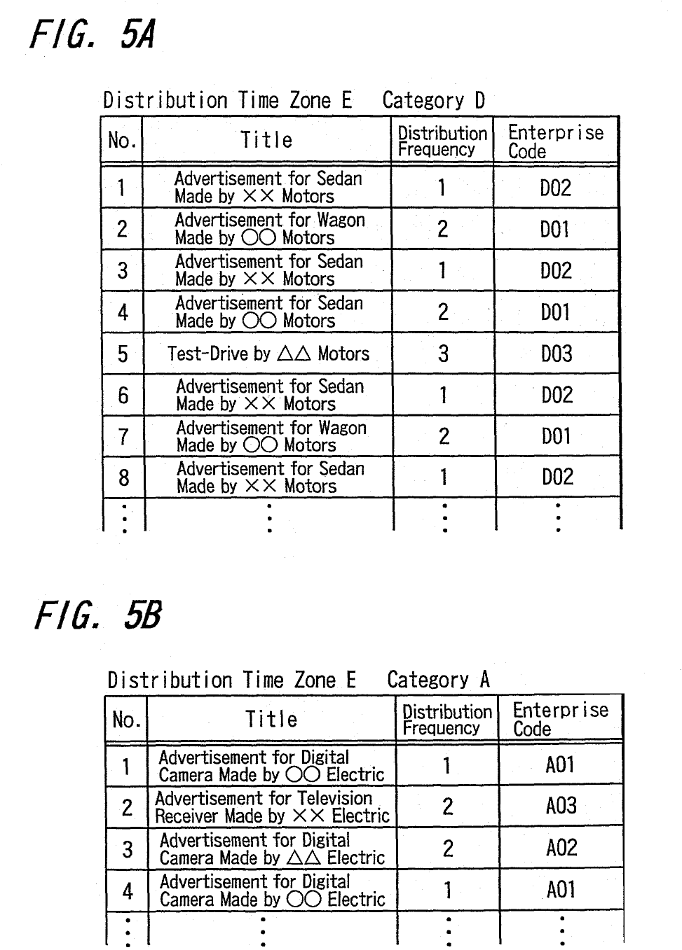

FIG. 5 shows examples of results obtained when these lists are made. FIG. 5A shows a list of CM materials of the category D (FIG. 2) distributed in the time zone E (FIG. 3). FIG. 5B shows a list of CM materials of the category A distributed in the time zone E.

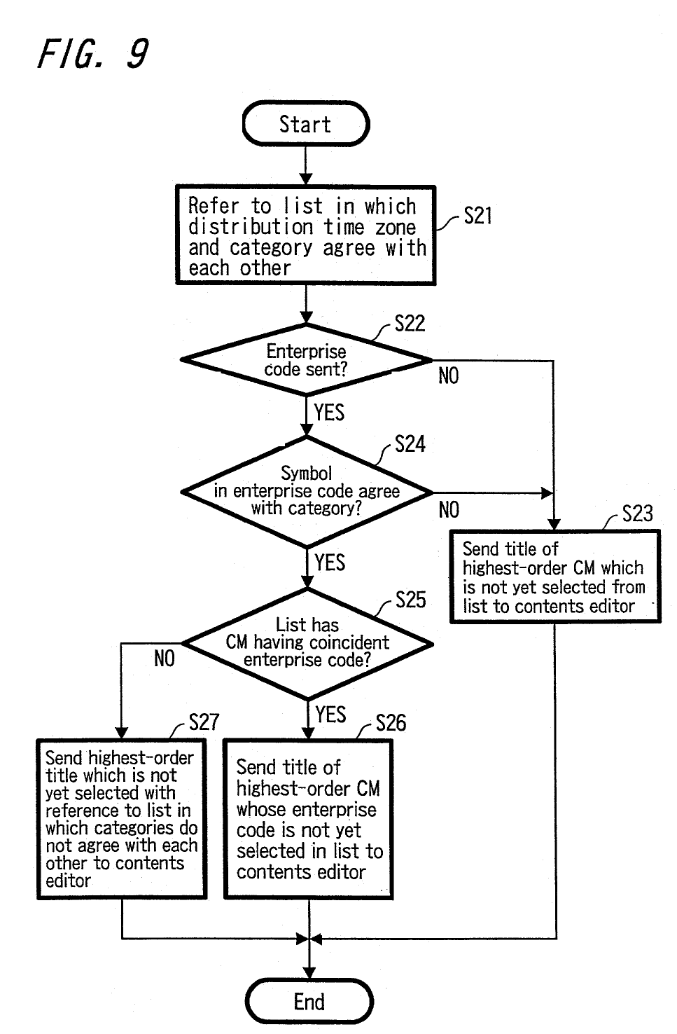

The CM scheduler 10 executes an application program for selecting CM materials from this list based upon the request from the contents editor 11 as will be described later on in the example of operations with reference to FIG. 9.

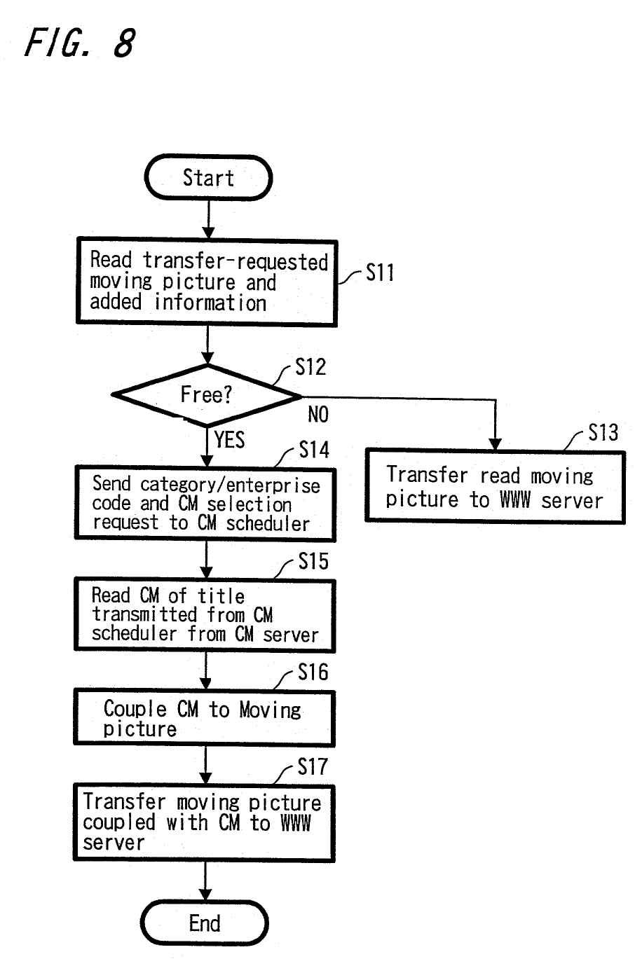

The contents editor 11 executes an application program for transferring files of moving picture contents to the WWW server 12 based upon the request from the WWW server 12 as will be described later on in the example of operations with reference to FIG. 8.

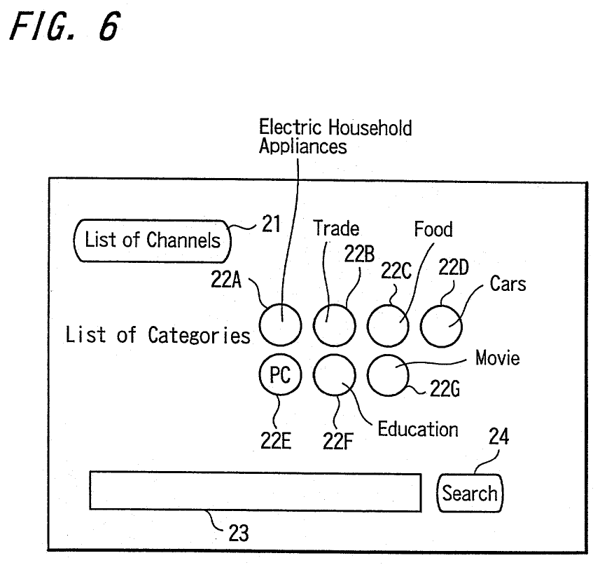

The WWW server 12 is opening a Web page on the Internet 15. FIG. 6 shows a-major portion of a display image of this Web page. The Web page includes an icon 21 for listing up and displaying contents in the sequential order of broadcasting channel numbers, icons 22A to 22G for listing up and displaying contents at every category shown in FIG. 2 and an icon 24 for listing up and displaying searched results of contents after the user had inputted keywords into a keyword input box 23.

Although not shown, a user of the moving picture distribution service (hereinafter simply referred to as a “user” or a “distribution requesting apparatus”) is able to select contents whose distribution was requested on this Web page by accessing the WWW server 12.

Files of still picture contents also are recorded on the hard disk incorporated within the WWW server 12 so that the user can select not only moving picture contents but also still picture contents.

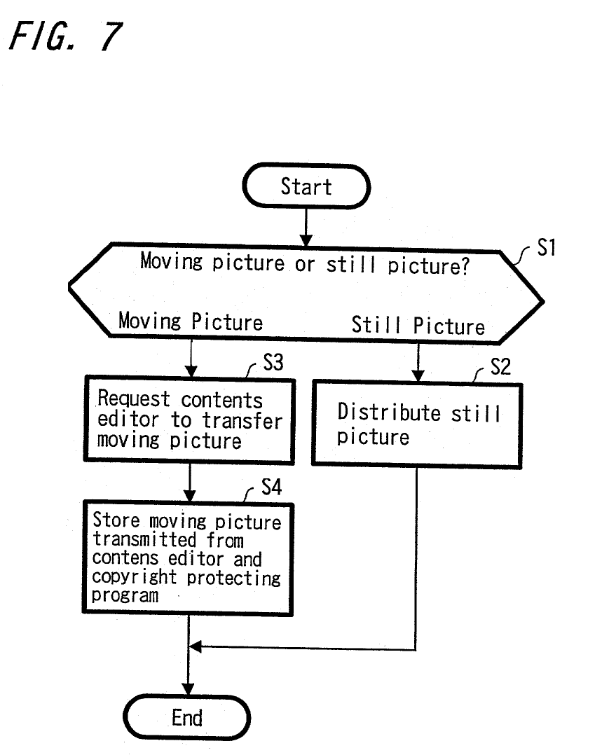

The WWW server 12 executes an application program for distributing contents based upon user's selection of contents as will be described later on in the examples of operations with reference to FIG. 7.

Next, the manner in which the distribution apparatus of FIG. 1 is operated based upon the fact that the user has selected contents will be described.

FIG. 7 shows steps executed by the WWW server 12 based upon the fact that the user has selected contents. When the WWW server 12 receives a contents distribution request via the Internet 15 after the user has selected the contents, it is determined by the WWW server 12 whether the contents distribution request is a moving picture contents distribution request or a still picture contents distribution request (step S1). If the contents distribution request is the still picture contents distribution request, then the still picture contents file is read out from the built-in hard disk and then distributed to the user (transmission source of contents distribution request) via the Internet 15 (step S2). Then, control is ended.

If on the other hand the contents distribution request is the moving picture contents distribution request, then the transmission request of the moving picture contents file is sent to the contents editor 11 (step S3).

FIG. 8 shows steps executed by the contents editor 11 based upon this transfer request. When the transfer request of the moving picture contents file is sent from the WWW server 12, the contents editor 11 reads out the moving picture contents file from the moving picture contents server 8 and sends a transmission request of added information added to the moving picture contents to the authoring PC 3, whereby the authoring PC 3 reads out the added information and sends the same (step S11). Then, it is determined based upon the free/pay information in the added information whether the moving picture contents are the free distributed moving picture contents or not (step S12).

If a NO is outputted (if the moving picture contents are the pay distributed moving picture contents), then the moving picture contents file thus read is transferred to the WWW server 12 as it is (step S13). Then, control is ended.

If on the other hand the moving picture contents are the free distributed moving picture contents, then category and enterprise code information in the read added information and a CM material selection request are sent to the CM scheduler 10 (step S14).

FIG. 9 shows steps executed by the CM scheduler 10 based upon this selection request. When the category and enterprise code information and the selection request are sent from the contents editor 11, the CM scheduler 10 refers to a list in which a time zone in which the selection request is transmitted and the distribution time zone agree with each other and the transmitted information and category agree with each other (step S21) (e.g., when the time zone in which the selection request is sent is 17.00 and information indicating the category D is sent, the CM scheduler refers to the list of FIG. 5A.

Then, it is determined whether or not the enterprise code information is sent (i.e., whether or not the moving picture contents distribution source is an enterprise) (step S22). If the enterprise code information is not sent (if the moving picture contents distribution source is an individual or an NPO) then a highest-order CM material of CM materials which are not yet selected (highest-order CM material in the list when this processing is first executed on this list) is selected from the list, and information indicative of a title of that CM material is sent to the contents editor 11 (step S23) (in the aforementioned example, when this processing is first executed on the list of FIG. 5A, information indicative of “a commercial of a sedan manufactured by XX motors” of the title of the CM material of No. 1 in this list is transmitted). Then, control is ended.

If on the other hand the enterprise code information is transmitted, then it is determined whether the symbols A to G in the enterprise code and the symbols A to G of the category of that list agree with each other (i.e., whether or not the contents of the distribution-requested moving picture contents are those of the field of the distribution source enterprise (step S24)).

If not, then control goes to a step S23. If on the other hand they agree with each other, then it is determined whether a CM material in which the transmitted information and the enterprise code agree with each other is on the list (step S25) (in the aforementioned example, when information indicative of an enterprise code D01, for example, is transmitted, it is determined whether or not the CM material of the enterprise code D01 is on the list of FIG. 5A).

If the above CM material is on the list, then a highest-order CM material of the CM materials of the enterprise codes which are not yet selected is selected from the list and the file name of the CM material thus selected is sent to the contents editor 11 (step S26) (in the aforementioned example, when this processing is first executed on the list of FIG. 5A, information indicative of title “a commercial of a wagon manufactured by ◯◯ motors” of the CM material of No. 2 of this list is transmitted). Then, control is ended.

If on the other hand the CM material is not on the list (in the aforementioned example, if the information indicative of the enterprise D04, for example, is transmitted and the CM material of the enterprise code D04 is not on the list of FIG. 5A), then lists in which the selection request transmitted time zone and the distribution time zone agree with each other and transmitted information and the category do not agree with each other are randomly selected (e.g., the list of FIG. 5B is selected) are selected and referred to. Then, the highest-order CM material of the CM materials which are not yet selected is selected from the list and information indicating the title of the CM material is sent to the contents editor 11 (step S27). Then, control is ended.

In this manner, when information indicative of the title of the CM material is transmitted from the CM scheduler 10 to the contents editor 11 at the step S23, S26 or S27, as shown in FIG. 8, the contents editor 11 reads out the file of the CM material with the above title from the CM server 9 (step S15). Then, the file of the CM material is coupled to the file of the moving picture contents read out at the step S11 (step S16).

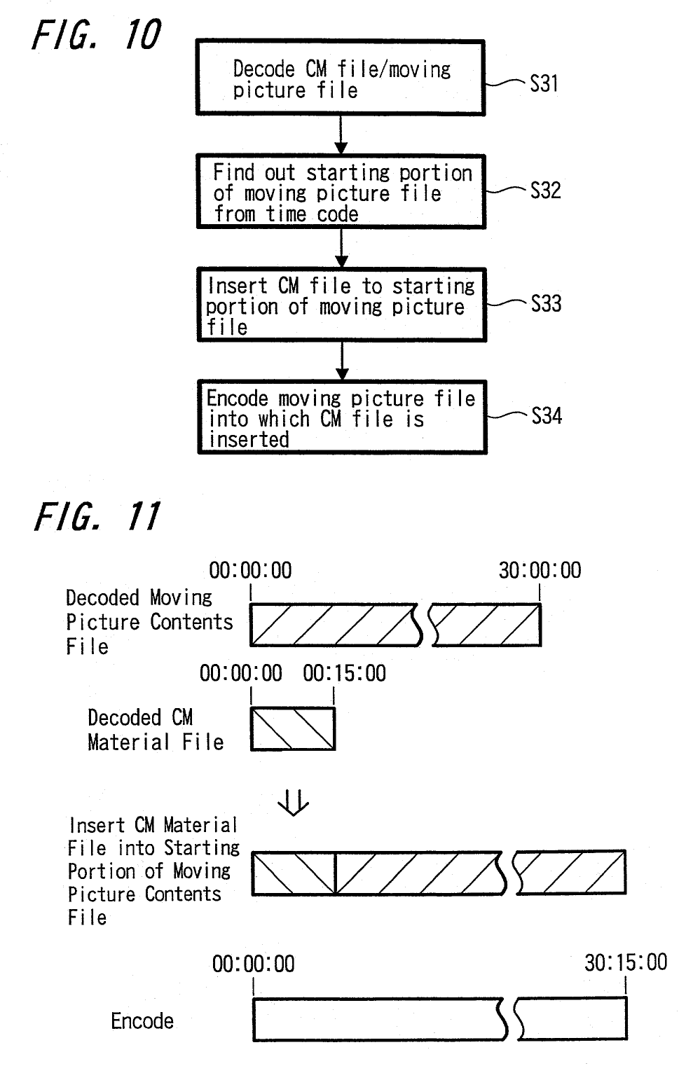

In this step S16, there may be used a well-known, proper file coupling method. FIG. 10 shows an example in which the processing of the step S16 is executed by using a simple nonlinear edit method. First, the CM material file and the moving picture contents file are both decoded (expanded) (step S31). subsequently, the starting portion of the file of the moving picture contents is discovered (step S32). Subsequently, the CM material file is coupled to the file of the moving picture contents by inserting the file of the CM material into the starting portion (step S33) of the file of the moving picture contents. Then, the file of the moving picture contents with the CM material file coupled thereto as described above is again encoded (compressed) (step S34).

FIG. 11 shows an example of the manner in which the file of the CM material is coupled to the file of the moving picture contents by the method of FIG. 10.

As shown in FIG. 8, after the contents editor 11 has finished the step S16, the contents editor assigns the same file name as that of the file of the moving picture contents to the file of the moving picture contents with the CM material coupled thereto and transfers that file to the WWW server 12 (step S17). Then, control is ended.

As described above, when the file of the moving picture contents with the CM material coupled thereto is transferred from the contents editor 11 to the WWW server 12 (or when the file of the moving picture contents is transferred from the contents editor 11 to the WWW server 12 at the step S13), as shown in FIG. 7, the WWW server 12 distributes the file of the moving picture contents and a copyright protecting application program (e.g., a program for erasing a moving picture contents file after moving pictures had been broadcast) to a user (transmission source of contents distribution request) through the Internet 15 (step S4). Then, control is ended.

While a method of collecting charges required when pay moving picture contents are distributed has not been described in this example of operations, such charges may be collected by a suitable method such as to force a user to enter a user's credit card number.

As described above, in this moving picture distribution service, when the distribution source of the moving picture contents whose distribution was requested by the user is the individual or the NPO or when the distribution source of the moving picture contents is the enterprise but the contents of the moving picture contents are not concerned with the field of the enterprise of the distribution source (in the case of the step S23 of FIG. 9), the CM material of the same category as that of the moving picture contents is distributed together with the above moving picture contents. As a result, since the commercial of the same category as that of moving pictures which the user wants to view is distributed, it is possible to increase a rate at which a commercial can attract a viewer's attention.

When the distribution source of the moving picture contents is the enterprise, the contents of the moving picture contents are concerned with the field of that enterprise and the CM material supplied from the above enterprise is on the list of the distribution time zone (in the case of the step S26 in FIG. 9), the CM material of the same category as that of the moving picture contents and which is supplied from the above enterprise is distributed together with the moving picture contents. As a result, a rate at which a commercial can attract a viewer's attention can be increased, and the advertising effects for that enterprise can be improved.

Further, when the distribution source of the moving picture contents is the enterprise, the contents of the moving picture contents are concerned with the field of that enterprise and the CM material supplied from that enterprise is not on the list of the distribution time zone (in the case of the step S27 in FIG. 9), a CM material of a category different from that of the moving picture contents is distributed together with the moving picture contents. As a result, it is possible to avoid such a situation in which a commercial of an enterprise (a different enterprise in the same business) which competes with a certain enterprise is distributed together with moving pictures supplied from a certain enterprise.

Since a certain commercial is distributed in the time zone during which there are many distribution requests from the sex/age class which is the target of a certain commercial, it is possible to further increase a rate at which a commercial can attract a viewer's attention.

In the above example, the lists in which transmitted information and categories do not agree with each other are randomly selected and referred to at the step S27 of FIG. 9. However, as another example, information indicative of a degree of an approximation of categories may be set (e.g., an approximation of a category of electric household appliances and a category of a computer may be set to be high) and lists of categories having a high approximation degree may be selected and referred to at the step S27 of FIG. 9.

According to this arrangement, when a commercial of a category different from that of a moving picture is distributed with a moving picture, it is possible to increase a rate at which a commercial can attract a viewer's attention.

In the above example, the title of the CM material of the same category as that of the moving picture contents whose distribution is requested this time is sent to the contents editor 11 at the steps S23 and S26 of FIG. 9. However, as another example, information indicative of a distribution request transmission source and information indicative of a category of contents whose distribution is requested may be recorded in a corresponding relationship each time a distribution request of contents is transmitted. Then, statistical data indicating a degree of a taste relative to each category may be accumulated at every transmission source which had transmitted the distribution request. Then, when a new distribution request may be transmitted from a transmission source which has the above statistical data, at the steps S23 and S26 of FIG. 9, lists of categories having a high degree of a taste for the transmission source may be referred to based upon the above statistical data, and the title of the CM material in the list may be transmitted to the contents editor 11.

As a result, since the CM of the category (this category is not always the same as that of the moving picture which the viewer now wants to watch) of the high degree of the taste for the user from a statistics standpoint are distributed together with a moving picture which the viewer now wants to view, it is possible to increase the rate at which the commercial can attract a viewer's attention.

While the free moving picture is distributed together with the commercial and the pay moving picture is distributed without commercial as described above, the present invention is not limited thereto, and the pay moving picture may be distributed with a commercial in the same way as the free moving picture is distributed with a commercial. Further, the classification of free/pay moving picture may be removed and all moving pictures may be set to free moving pictures (or pay moving pictures) and distributed with commercials.

While the present invention is applied to the moving picture distribution service for distributing a moving picture through the Internet as described above, the present invention is not limited thereto and may be applied to a moving picture distribution service (e.g., a moving picture distribution service based on a two-way CATV) for distributing a moving picture through a communication network which is capable of executing a two-way communication except the Internet.

It is needless to say that the present invention is not limited to the above embodiment and that the present invention can take various modifications without departing from the gist of the invention.

As described above, according to the present invention, since the commercial of the category in which the user who has requested the distribution is highly interested can be distributed by selecting the category of the commercial at every category of the moving picture whose distribution was requested (e.g., selecting the commercial of the same category as that of the moving picture whose distribution was requested), there can be achieved an effect that a rate at which a commercial can attract a viewer's attention can be increased.

Further, by selecting the commercial at very distribution source of the moving picture whose distribution was requested, there can be achieved an effect that it is possible to avoid a situation in which a commercial of a distribution source (a different company in the same business) which competes with a certain distribution source is distributed together with a moving picture from a certain distribution source.

Furthermore, by distributing a commercial suitable for a time zone whose distribution is requested, there can be achieved an effect that it is possible to further increase a rate at which a commercial can attract a viewer's attention.

1. An apparatus for distributing a moving picture with a commercial comprising:
setting means for setting category information indicating categories to a plurality of moving image data which are to be distributed and a plurality of commercial image data which are to be distributed;
selecting means for-selecting said commercial image data in which any of said category information is set based upon said category information set to the moving image data whose distribution was requested each time a distribution request of any of said moving image data is received via a communication network capable of executing a two-way communication; and
coupling means for coupling commercial image data selected by said selecting means to said moving image data whose distribution was requested, wherein moving image data to which commercial image data is coupled by said coupling means is distributed to said distribution request transmission source via said communication network.

2. An apparatus for distributing a moving picture with a commercial according to claim 1, wherein said selecting means selects commercial image data to which said category information as said moving image data whose distribution was requested is set.

3. An apparatus for distributing a moving picture with a commercial according to claim 1, further comprising:
setting means for setting distribution source information indicating data distribution sources to said moving image data and said commercial image data and wherein said selecting means selects said commercial image data in which any of said distribution source information is set based upon said distribution source information set to said moving image data whose distribution was requested.

4. An apparatus for distributing a moving picture with a commercial according to claim 2, further comprising:
setting means for setting distribution source information indicating data distribution sources to said moving image data and said commercial image data and wherein said selecting means selects said commercial image data in which any of said distribution source information is set based upon said distribution source information set to said distribution request moving image data.

5. An apparatus for distributing a moving picture with a commercial according to claim 1, further comprising:
setting means for setting time zone information indicating distribution time zones to said commercial image data and wherein said selecting means selects said commercial image data to which said time zone information which agrees with a time zone in which said distribution request is received is set.

6. An apparatus for distributing a moving picture with a commercial according to claim 2, further comprising:
setting means for setting time zone information indicating distribution time zones to said commercial image data and wherein said selecting means selects said commercial image data to which said time zone information which agrees with a time zone in which said distribution request is received is set.

7. An apparatus for distributing a moving picture with a commercial according to claim 3, further comprising:
setting means for setting time zone information indicating distribution time zones to said commercial image data and wherein said selecting means selects said commercial image data to which said time zone information which agrees with a time zone in which said distribution request is received is set.

8. An apparatus for distributing a moving picture with a commercial according to claim 4, further comprising:
setting means for setting time zone information indicating distribution time zones to said commercial image data and wherein said selecting means selects said commercial image data to which said time zone information which agrees with a time zone in which said distribution request is received is set.

9. A method of distributing a moving picture with a commercial comprising the steps of:
a first step of setting category information indicating categories to a plurality of moving image data which are to be distributed. and a plurality of commercial image data which are to be distributed;
a second step of selecting said commercial image data in which any of said category information is set based upon said category information set to the moving image data whose distribution was requested each time a distribution request of any of said moving image data is received via a communication network capable of executing a two-way communication;
a third step of coupling commercial image data selected at said second step to said moving image data whose distribution was requested; and
a fourth step of distributing moving image data to which commercial image data is coupled at said third step to said distribution request transmission source via said communication network.

10. A method of distributing a moving picture with a commercial according to claim 9, wherein said second step selects commercial image data to which said category information as said moving image data whose distribution was requested is set.

11. A method of distributing a moving picture with a commercial according to claim 9, further comprising:
a step of setting distribution source information indicating data distribution sources to said moving image data and said commercial image data and wherein said second step selects said commercial image data in which any of said distribution source information is set based upon said distribution source information set to said moving image data whose distribution was requested.

12. A method of distributing a moving picture with a commercial according to claim 10, further comprising:
a step of setting distribution source information indicating data distribution sources to said moving image data and said commercial image data and wherein said second step selects said commercial image data in which any of said distribution source information is set based upon said distribution source information set to said moving image data whose distribution was requested.

13. A method of distributing a moving picture with a commercial according to claim 9, further comprising:
a step of setting time zone information indicating distribution time zones to said commercial image data and wherein said second step selects said commercial image data to which said time zone information which agrees with a time zone in which said distribution request is received is set.

14. A method of distributing a moving picture with a commercial according to claim 10, further comprising:
a step of setting time zone information indicating distribution time zones to said commercial image data and wherein said second step selects said commercial image data to which said time zone information which agrees with a time zone in which said distribution request is received is set.

15. A method of distributing a moving picture with a commercial according to claim 11, further comprising:
a step of setting time zone information indicating distribution time zones to said commercial image data and wherein said second step selects said commercial image data to which said time zone information which agrees with a time zone in which said distribution request is received is set.

16. A method of distributing moving picture with commercial according to claim 12, further comprising:
a step of setting time zone information indicating distribution time zones to said commercial image data and wherein said second step selects said commercial image data to which said time zone information which agrees with a time zone in which said distribution request is received is set.

17. A computer readable recording medium on which there is recorded a program for executing:
a first step of setting category information indicating categories to a plurality of moving image data which are to be distributed and a plurality of commercial image data which are to be distributed;
a second step of selecting said commercial image data in which any of said category information is set based upon said category information set to the moving image data whose distribution was requested each time a distribution request of any of said moving image data is received via a communication network capable of executing a two-way communication;
a third step of coupling commercial image data selected at said second step to said moving image data whose distribution was requested; and
a fourth step of distributing moving image data to which commercial image data is coupled at said third step to said distribution request transmission source via said communication network.

18. A computer readable recording medium according to claim 17, wherein second step selects commercial image data to which said category information as said moving image data whose distribution was requested is set.

19. A computer readable recording medium according to claim 17, further comprising:
a step of setting distribution source information indicating data distribution sources to said moving image data and said commercial image data and wherein said second step selects said commercial image data in which any of said distribution source information is set based upon said distribution source information set to said moving image data whose distribution was requested.

20. A computer readable recording medium according to claim 18, further comprising:
a step of setting distribution source information indicating data distribution sources to said moving image data and said commercial image data and wherein said second step selects said commercial image data in which any of said distribution source information is set based upon said distribution source information set to said moving image data whose distribution was requested.

21. A computer readable recording medium according to claim 17, further comprising:
a step of setting time zone information indicating distribution time zones to said commercial image data and wherein said second step selects said commercial image data to which said time zone information which agrees with a time zone in which said distribution request is received is set.

22. A computer readable recording medium according to claim 18, further comprising:
a step of setting time zone information indicating distribution time zones to said commercial image data and wherein said second step selects said commercial image data to which said time zone information which agrees with a time zone in which said distribution request is received is set.

23. A computer readable recording medium according to claim 19, further comprising:
a step of setting time zone information indicating distribution time zones to said commercial image data and wherein said second step selects said commercial image data to which said time zone information which agrees with a time zone in which said distribution request is received is set.

24. A computer readable recording medium according to claim 20, further comprising:
a step of setting time zone information indicating distribution time zones to said commercial image data and wherein said second step selects said commercial image data to which said time zone information which agrees with a time zone in which said distribution request is received is set.

25. An apparatus for requesting a distribution of a moving picture with a commercial comprising:
distribution requesting means for requesting that any of moving image data is distributed from a plurality of distributed moving image data through a communication network which is capable of executing a two-way communication; and
receiving means for setting category information indicative of respective categories to said plurality of distributed moving image data and a plurality of commercial image data distributed with said moving image data, selecting said commercial image data to which any of said category information is set based upon said category information set to said moving image data whose distribution was requested and receiving moving image data which results from coupling said selected commercial image data and said moving image data whose distribution was requested through said communication network.

26. An apparatus for requesting a distribution of a moving picture with a commercial according to claim 25, wherein said selection selects commercial image data to which the same category information as said moving image data whose distribution was requested is set.

27. An apparatus for requesting a distribution of a moving picture with a commercial according to claim 25, wherein distribution source information indicative of data distribution sources are further set to said moving image data and said commercial image data and said selection further selects said commercial image data to which any of said distribution source information is set based upon said distribution source information set to said moving image data whose distribution was requested.

28. An apparatus for requesting distribution of moving picture with commercial according to claim 26, wherein distribution source information indicative of data distribution sources are further set to said moving image data and said commercial image data and said selection further selects said commercial image data to which any of said distribution source information is set based upon said distribution source information set to said moving image data whose distribution was requested.

29. An apparatus for requesting a distribution of a moving picture with a commercial according to claim 25, wherein time zone information indicative of a distribution time zone is further set to said commercial image data and said selection selects said commercial image data to which said time zone information coincident with a time zone during which said distribution request is received is set.

30. An apparatus for requesting a distribution of a moving picture with a commercial according to claim 26, wherein time zone information indicative of a distribution time zone is further set to said commercial image data and said selection selects said commercial image data to which said time zone information coincident with a time zone during which said distribution request is received is set.

31. An apparatus for requesting a distribution of a moving picture with a commercial according to claim 27, wherein time zone information indicative of a distribution time zone is further set to said commercial image data and said selection selects said commercial image data to which said time zone information coincident with a time zone during which said distribution request is received is set.

32. An apparatus for requesting a distribution of a moving picture with a commercial according to claim 28, wherein time zone information indicative of a distribution time zone is further set to said commercial image data and said selection selects said commercial image data to which said time zone information coincident with a time zone during which said distribution request is received is set.
